(19) United States
(12) Patent Application Publication
(10) Pub. No.: US 2024/0269494 A1
(43) Pub. Date: Aug. 15, 2024

(54) FACE COVERING

(71) Applicant: 3M INNOVATIVE PROPERTIES COMPANY, St. Paul, MN (US)

(72) Inventors: Nicholas K. Lee, Maplewood, MN (US); Liyun Ren, Woodbury, MN (US); Tanya L. Beckwith, Maplewood, MN (US); Gina M. Daveloose, Maplewood, MN (US); Jeffrey G. Linert, Woodbury, MN (US); Jacob T. Lusson, Richfield, MN (US); John D. Stelter, Osceola, WI (US); Jacob J. Thelen, Minneapolis, MN (US)

(21) Appl. No.: 18/681,792

(22) PCT Filed: Aug. 15, 2022
(86) PCT No.: PCT/IB2022/057636

§ 371 Date: Feb. 6, 2024

Related U.S. Application Data
(60) Provisional application No. 63/232,638, filed on Aug. 13, 2021.

(51) Int. Cl. A62B 23/02; B01D 39/16

(52) U.S. Cl. CPC A62B 23/02; B01D 39/163; B01D 2239/0435; B01D 2239/0627; B01D 2239/065

(57) ABSTRACT

Provided are face coverings that include a cover panel made from a cover panel material, a filter made from a filtration media adjacent the cover panel, and a retaining system for securing the face covering to a wearer's face. The face coverings can further include a gasket comprising gasket material connected to a perimeter of the cover panel and configured to contact to a wearer's face. The pressure drop across a combination of the cover panel material and the filtration media is from 45% to 75% of the pressure drop across the gasket material, enabling filtration of airborne contaminants allowing for reduced retaining tension and improved comfort to the wearer.

### FIELD OF THE INVENTION

The present disclosure generally relates to the field of face coverings. In particular, the present disclosure relates to face coverings for barrier protection against airborne contaminants.

### BACKGROUND

The COVID-19 pandemic has rapidly exposed the public to the concept of respiratory protection, often provided by respirators and face coverings. Respirators provide protection for the user from the environment, but require a tight seal around the consumer's nose, mouth and chin to be effective. This can cause the respirator to be uncomfortable to wear, affecting compliance and willingness to wear the respirator. Face coverings can provide a means of source control for viral spread from the user and require a less tight fit around the user's nose, mouth and chin. Thus, while face coverings tend to fit more comfortably on a user, they can provide less protection to the user.

Recent efforts to standardize the quality of barrier face coverings to meet ASTM F3502 focus primarily on sub-micron particulate filtering efficiency and airflow resistance. Diverging from the occupational facing NIOSH requirements of loading capacity and filtering performance enables technical pathways to improve the product experience and worn comfort. Worn comfort is significant because it heavily drives wear compliance, particularly over longer wear-times.

### SUMMARY

Common consumer pain points to wearing face coverings and respirators include fogging of glasses, breathability, pressure sores, ear loop aches, and skin contact with uncomfortable materials. All of these pain points directly correlate with the retaining tension required to maintain a respirator or face covering on the face for a tight seal. Other common consumer comfort pain points often revolve around fit, lip contact during wear, a claustrophobic experience, muffling or decreased speech intelligibility.

Provided are face coverings with an easy breathing experience of filtered air. This experience is enabled by a very low pressure drop across a filter. The low pressure drop filtration allows a comfortable, “gentle” face contact wear while providing an improved fit with a low leakage face covering design. In addition to reducing breathing resistance relative to respirators and/or conventional face coverings, the provided face covering can afford various secondary comfort benefits that exploit the low pressure drop of its filtration media. For example, it is possible to achieve a snug-fit face covering with high fit factor performance and utilizing comfortable (e.g., breathable) materials with gentle face contact, while retaining high filtration efficiency.

In an first aspect, a face covering is provided. The face covering comprises: (a) a cover panel comprising cover panel material and having a front major surface and a rear major surface and a perimeter; (b) a filter comprising filtration media adjacent at least portion of the rear major surface of the cover panel: (c) a gasket comprising gasket material connected to the perimeter of the cover panel configured to conform to a wearer's face; and (d) a retaining system for securing the face covering to a wearer's face: wherein the pressure drop across a combination of the cover panel material and the filtration media is from 45% to 75% of the pressure drop across the gasket material, as measured according to ASTM F3502.

In a second aspect, a face covering is provided, comprising: a cover panel comprising cover panel material and having a front major surface and a rear major surface: a filter comprising filtration media adjacent at least portion of the rear major surface of the cover panel; an inner panel comprising an inner panel material adjacent to the filter, wherein the inner panel is configured to conform to a wearer's face; and a retaining system for securing the face covering to a wearer's face, wherein the filtration media has a solidity gradient along its thickness dimension.

### BRIEF DESCRIPTION OF THE DRAWINGS

FIG. 1 is a frontal view of a face covering according to one exemplary embodiment.

FIG. 2 is a rear view of the face covering of FIG. 1, with a replacement filter partially inserted therein.

FIG. 3 is a rear view of the face covering of FIGS. 1-2, with the replacement filter installed.

FIG. 4 is side view of the face covering of FIGS. 1-3 being worn.

FIG. 5 is a rear view of a face covering according to another exemplary embodiment.

FIG. 6 is a side view of the face covering of FIG. 5.

FIG. 7 is a fragmentary cross-sectional view of the face covering of FIGS. 5 and 6.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definitions

“Ambient conditions” means at 21° C. and 101.3 kilopascals:

“ASTM D737” refers to the ASTM International standard under the designation D737.

“ASTM F3407” refers to the ASTM International standard under the designation F3407-21, published November 2021, with certain deviations that are enumerated in the Examples.

“ASTM F3502” refers to the ASTM International standard under the designation F3502-21, published February 2021. Deviations are identical to those for ASTM F3407 above.

“Electret” refers to a stable dielectric material with a quasi-permanently embedded static electric charge (which, due to the high resistance of the material, will not decay for an extended time period of up to hundreds of years) and/or a quasi-permanently oriented dipole polarization.

“Gsm” stands for grams per square meter.

“Pressure drop” refers to a measured reduction in pressure, as obtained using the method described in the Examples.

“Spunbond” refers to a method for forming a non-woven electret fibrous web by extruding molten fiber-forming material as continuous or semi-continuous fibers from a plurality of fine capillaries of a spinneret (melt spinning), and thereafter collecting the attenuated fibers.

“Thickness” refers to an average thickness or nominal thickness of a layer, as measured perpendicular to a major surface of the layer.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises”, and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described relating to the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. All measurements are made under ambient conditions unless otherwise indicated.

A face covering according to one exemplary embodiment is illustrated in FIGS. 1-4 and hereafter designated by the numeral 100. As shown in these figures, the face covering 100 includes a cover panel 102, a filter 104, a gasket 106 having an annular shape and defining an aperture 116, and a retaining system 108 for securement of the face covering 100 to the face of a wearer 114. The aperture 116 can have any suitable size and shape to accommodate the nose and mouth of the wearer. The area of the aperture 116 can extend over from 30 percent to 90 percent. 35 percent to 80 percent, 40 percent to 70 percent, or in some embodiments, less than, equal to, or greater than 30 percent, 35, 40, 45, 50, 55, 60, 65, 70, 75, 80, 85, or 90 percent of the overall rear-facing surface area of the cover panel 102. Operation of the retaining system 108 is shown in FIG. 4.

The cover panel 102, filter 104, and gasket 106 are made from a cover panel material, filtration media, and gasket material, respectively. As used herein, the cover panel material, filtration media, and gasket material refer to stock materials capable of being characterized using the test methods described herein, where applicable.

Optionally and as shown, the retaining system 108 is includes a pair of straps 110 and associated buckles 112 for adjusting tension of each strap 110 when fitted about the cars of the wearer 114. The ends of the straps 110 can be stitched, adhesively coupled, welded, or otherwise fastened to the lateral edges of the cover panel 102, gasket 106, or both. Alternative retaining systems are also possible. For example, one or more elastic straps could be secured at their ends to the sides of the cover panel 102 and snugly fitted around the head of the wearer 114. Conveniently, straps can be constructed from the same material as that used for the gasket 106.

In more detail, the cover panel 102 has a front major surface and an opposing rear (i.e., wearer-side) major surface. The filter 104 is comprised of a filtration media and is adjacent to at least a portion of the rear major surface. Here, the filter 104 is a replaceable component, while the cover panel 102 and gasket 106 are non-replaceable components. The cover panel 102 and gasket 106 are optionally washable. The gasket 106 and cover panel 102 can be stitched, adhesively bonded, or otherwise permanently coupled to each other along their respective perimeters. Optionally and as shown, a chin panel 107 extends outwardly along a bottom edge of the cover panel 102, and is shaped to fit conformably against the chin of the wearer 114 as shown in FIG. 4.

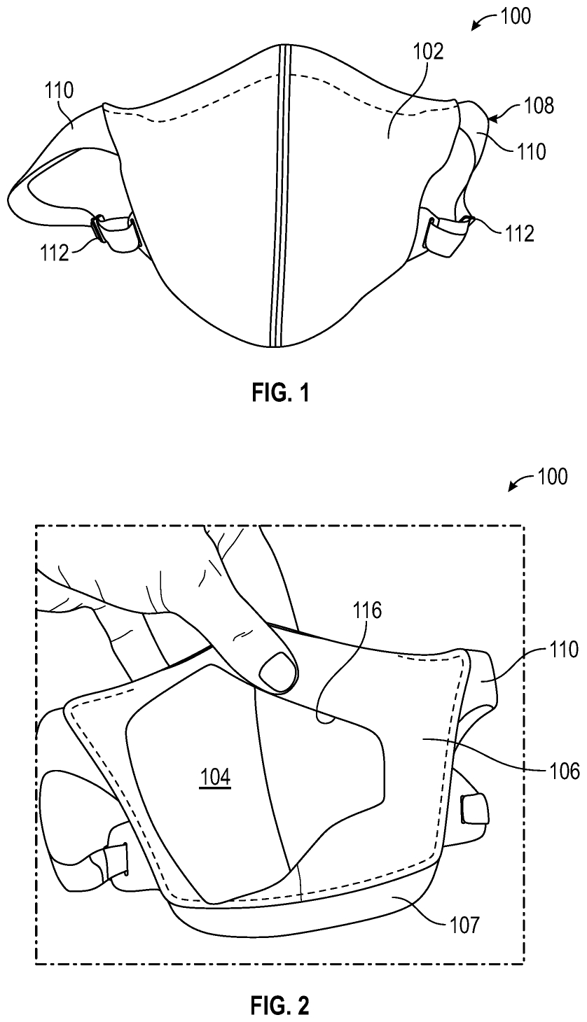

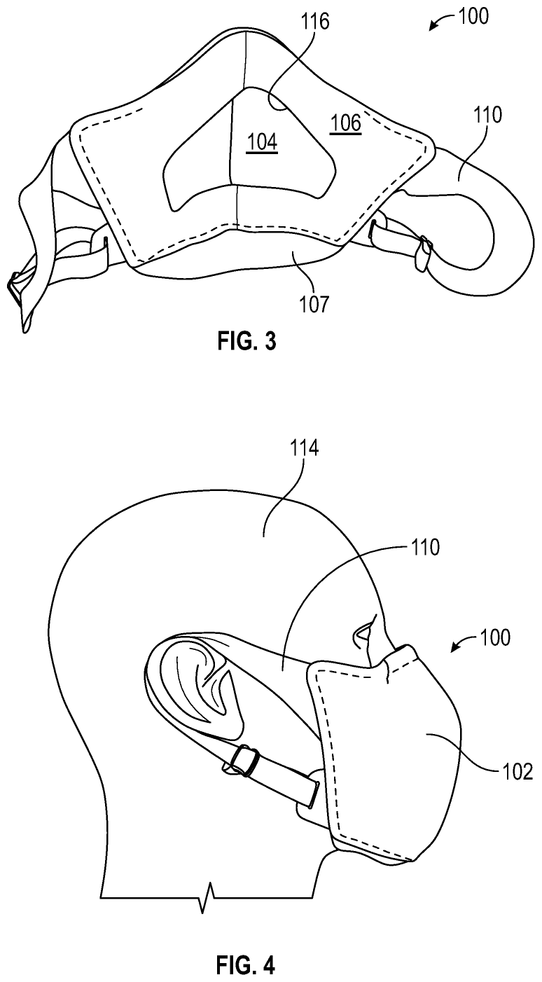

FIG. 2 depicts the filter 104 partially inserted into the space between the cover panel 102 and gasket 106, while FIG. 3 depicts the face covering 100 after installation. In these figures, the filter 104 is oversized relative to the aperture 116 in these rear views, enabling it to be secured within the face covering 100 by an interference fit. As it is generally thin and flexible, the filter 104 can be conveniently installed and removed by hand.

The cover panel 102 and filter 104 act as a low-resistance airflow pathway, while the gasket 106, counterintuitively, acts as a respiratory seal. Preferably, there a sufficient contact area of the gasket 106 against the face of the wearer 114 along a continuous, circuitous path encircling around the wearer's nose and mouth. This configuration can provide the wearer 114 with a filtered breathing area while avoiding any significant leakage around the face covering during breathing.

Because fluid (breathed air and entrained particles) follows the path of least resistance, the respiratory seal exploits a sufficiently high-pressure differential to bias airflow such that it travels through the filter 104 and cover panel 102 rather than through the gasket 106. It can be beneficial for the collective pressure drop through the cover panel material and filtration media to be from 45% to 75%, or in some embodiments, less than, equal to, or greater than 45%, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75% the pressure drop across the gasket material to provide a functional respiratory seal.

Examples of suitable cover panel materials with sufficiently low-pressure drop can include but are not limited to knit polyester spacer mesh, knit nylon mesh, or a highly porous non-woven. In certain embodiments, the cover panel material can be inelastic.

The cover panel material can have any suitable thickness, such as from 1.5 millimeters to 3 millimeters, or in some embodiments, less than, equal to, or greater than 1.5 millimeters, 1.6, 1.7, 1.8, 1.9, 2, 2.1, 2.2, 2.3, 2.4, 2.5, 2.6, 2.7, 2.8, 2.9, or 3 millimeters. Finally, useful cover panel materials can display a pressure drop of from 0.05 mm H₂O to 1 mm H₂O, or in some embodiments, less than, equal to, or greater than 0.05 mm H₂O, 0.06, 0.07, 0.08, 0.09, 0.1, 0.12, 0.15, 0.17, 0.2, 0.3, 0.4, 0.5, 0.6, 0.7, 0.8, 0.9, or 1 mm H₂O.

The filter 104 can have a similar size and shape to the cover panel 102 such that the two components are substantially coextensive with each other when assembled within the face covering 100. Preferably, the filter 104 also displays a relatively low pressure drop relative to the gasket 106 such that air preferentially flows through the filter 104 and cover panel 102 instead of the gasket 106. The pressure drop, or airflow resistance, and sub-micron filtration efficiency are as defined in ASTM F3502 & 42 CFR Part 84.

In useful embodiments, the filter is comprised of a high loft spunbond fibrous web. The filter can have at least about 80% sub-micron filtration efficiency, preferably at least about 85% sub-micron filtration efficiency, more preferably at least about 90% sub-micron filtration efficiency, more preferably at least about 93% sub-micron filtration efficiency, and even more preferably at least about 95% filtration efficiency, as measured according to ASTM F3502.

The filtration media can have a thickness that sufficiently provides an acceptable filtration performance while allowing for sufficient flexibility for the filter 104 to be easily inserted into and removed from the face covering 100. The thickness can be from 0.6 millimeters to 1.75 millimeters, or in some embodiments, less than, equal to, or greater than 0.6 millimeters, 0.65, 0.7, 0.75, 0.8, 0.85, 0.9, 0.95, 1, 1.1, 1.2, 1.3, 1.4, 1.5, 1.6, 1.7, or 1.75 millimeters. Related to this, the filtration media can have a basis weight of from 20 gsm to 120 gsm, or in some embodiments, less than, equal to, or greater than 20 gsm, 25, 30, 35, 40, 45, 50, 55, 60, 65, 70, 75, 80, 85, 90, 95, 100, 105, 110, 115, or 120 gsm.

Depending in part on its thickness and basis weight, the filtration media on its own can display a pressure drop of from 0.5 mm H₂O to 5 mm H₂O, or in some embodiments less than, equal to, or greater than 0.5 mm H₂O, 0.6, 0.7, 0.8, 0.9, 1, 1.1, 1.2, 1.3, 1.4, 1.5, 1.6, 1.7, 1.8, 1.9, 2, 2.2, 2.5, 2.7, 3, 3.5, 4, 4.5, or 5 mm H₂O.

The gasket material is preferably a breathable material for enhanced wearer comfort. For this application, breathability is defined as greater than about 2 cfm per ASTM D737. The gasket 106 is made from a material that results in a pressure drop sufficiently higher than the pressure drop through the filter 104 and cover panel 102. In one embodiment, the gasket material is made from a woven fabric. It can be advantageous for the gasket material to be resilient—i.e., return to its original shape when stretched, with little or no permanent deformation. This preserves the ability of the gasket to continue providing the ability to conform to the shape of the face and create an adequate seal against the face.

Exemplary gasket materials having the above properties include stretchy knit materials, such as polyester-spandex knits, nylon-spandex knits, or an elastic non-woven. Gasket materials can also use blended compositions, such as a blend comprising at least 2% spandex/elastane. The gasket can assume any number of shapes and sizes as long as it sufficiently forms a gentle seal around the perimeter of the filtered breathing area. For the comfort of the wearer, the gasket material is preferably soft to the touch.

The gasket material can have any suitable thickness that preserves breathability and yet also provide a sufficiently high pressure drop to direct airflow through the filter 104 and cover panel 102. The thickness of the gasket material can be from 0.3 millimeters to 1.2 millimeters, or in some embodiments, less than, equal to, or greater than 0.3 millimeters, 0.4, 0.45, 0.5, 0.55, 0.6, 0.65, 0.7, 0.75, 0.8, 0.85, 0.9, 0.95, 1, 1.05, 1.1, 1.15, or 1.2 millimeters.

Again depending on its thickness and basis weight, the gasket material can display a pressure drop of from 2 mm H₂₀ to 20 mm H₂O, or in some embodiments less than, equal to, or greater than 2 mm H₂O, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, or 20 mm H₂O, as measured according to ASTM F3502.

By way of comparison, the pressure drop across a combination of the cover panel material and the filtration media together is from 0.5 mm H₂O to 5 mm H₂O, or in some embodiments less than, equal to, or greater than 0.5 mm H₂O, 0.6, 0.7, 0.8, 0.9, 1, 1.1, 1.2, 1.3, 1.4, 1.5, 1.6, 1.7, 1.8, 1.9, 2, 2.2, 2.5, 2.7, 3, 3.2, 3.5, 3.7, 4, 4.2, 4.5, 4.7, or 5 mm H₂O, as measured according to ASTM F3502. The pressure drop of the overall face covering 100 is expected to be similar to that measured across the cover panel material and the filtration media together, as the addition of the annular gasket 106 does not appreciably increase pressure drop.

The retaining system 108 allows the face covering to have a “snug” fit wear, which are differentiated from tight-fitting respirators or loose-fitting medical face coverings (per ASTM F3502-21 Standard Specifications for Barrier Face Coverings). The retaining system is low-tension and results in improved worn comfort while retaining fit factors of at least about 5 or more, based on a modified ASTM F3407. In one embodiment, the retaining system is at a minimum 10 mm wide, spaced at optimized (for adult sizing) 5 cm±1 cm apart. Notably, the face covering 100 can provide adequate filtration performance even when the wearer has facial hair, such as a beard.

Further, the face covering 100 can provide an excellent Fit Factor (per ASTM F3407) performance without a tight fit. In some cases, the Fit Factor is about 5 or greater, preferably about 10 or greater, and more preferably about 15 or greater. In one embodiment, the face covering of the present invention can reduce inhaled concentration of PM2.5 particles from outside environments by at least about 5 times, preferably at least about 10 times, more preferably at least about 15 times, and even more preferably at least about 20 times.

In a preferred embodiment, the filtration media is made from a non-woven fibrous web. Useful non-woven fibrous webs can comprise high loft spunbond fibrous webs, for example, as described in U.S. Pat. No. 8,240,484 (Fox, et al.). In some embodiments, the spunbond fibrous webs include a multiplicity of randomly oriented discrete fibers comprising electret fibers. Electret fibers are described in, for example, U.S. Pat. No. 4,215,682 (Kubik, et al.); U.S. Pat. No. 5,643,507 (Berrigan et al.); U.S. Pat. No. 5,658,640 (Berrigan et al.); U.S. Pat. No. 5,658,641 (Berrigan et al.); U.S. Pat. No. 6,420,024 (Perez, et al.); U.S. Pat. No. 6,645,618 (Hobbs, et al.); U.S. Pat. No. 6,849,329 (Perez, et al.); and U.S. Pat. No. 7,691,168 (Fox, et al.).

The provided fibers can be formed by extruding filaments out of a set of orifices and allowing the filaments to cool and solidify to form fibers, with the filaments passing through an air space (which may contain streams of moving air) to assist in cooling the filaments and passing through an attenuation (i.e., drawing) unit to at least partially draw the filaments. Meltspinning can be distinguished from meltblowing, which involves extrusion of extruded filaments into converging high velocity air streams introduced by way of air-blowing orifices located in close proximity to the extrusion orifices. To obtain a spunbond web, meltspun fibers can be collected as a fibrous web and optionally subjected to one or more bonding operations.

Meltspun fibers can be laid down semi-randomly on a moving collector belt forming a nonwoven web and held in place by vacuum until passing through an air-driven bonding zone where the spunbond web is formed via a through-air bonder, after which it can be taken up on a surface winder. Advantageously, varying the temperature and the position of the through-air bonder enables manufacture of a non-woven web having a dual-layer structure and/or a solidity gradient—i.e., one in which solidity varies with depth. These webs are especially advantageous in face covering applications because they enable a very low pressure drop while also providing superior filtration efficiency. As further advantages, these webs can provide a tighter pressure drop distribution across the major surface of the web and fewer loose fibers.

The low-pressure drop is attributable to the controlled fiber size and fiber lay-down process in the nonwoven structure. The fiber size of nonwoven media is generally larger than the melt-blown fibers used in traditional face mask filtration media. The high filtration of the nonwoven is originated from enhanced uniformity of the nonwoven web with a dual-layer structure and gradient fiber bonding of the electrostatic charged filtration media. A dual-layer structure refers to a combination of two non-woven web layers formed cumulatively in series or made as separate webs that are subsequently laminated together. By averaging properties across the surface of the web, it is possible to obtain a significantly more uniform web overall, relative to that of the individual layers.

The dual-layer structure and gradient fiber bonding can provide uniformity cross web comparing to single-layered spunbond web since the pore size is controlled by gradient fiber lay-down.

Electrostatic charging was observed to provide a synergistic effect with the provided web structures above by attracting air born particulates through electrostatic interactions. The presence of either uncompensated space charge or oriented dipoles present within the media can create more uniform electric fields that contributes to the great enhancement of filtration properties of electret charged media. Inhomogeneous electric fields within the filter structure creates field gradients to capture particulates throughout the nonwoven media.

In some embodiments, an electrostatic charge can be applied to uncharged fibers using an electrostatic applying technology. Thus, suitable electret fibers may be produced by forming fibers in an electric field. For example, it is possible to melt a suitable dielectric polymer containing polar molecules, pass the molten material through a die to form discrete fibers, and then allow the molten polymer to re-solidify while the discrete fibers are exposed to a powerful electrostatic field. Electret fibers may also be made by embedding excess charges into a polymer or other highly insulating dielectric material using an electron beam, a corona discharge, injection from an electron, electric breakdown across a gap, or a dielectric barrier.

Particularly suitable electret fibers include hydrocharged fibers. Hydrocharging of fibers may be carried out using a variety of techniques including impinging, soaking or condensing a polar fluid onto the fiber, followed by drying, so that the fiber becomes charged. Representative patents describing hydrocharging include U.S. Pat. No. 5,496,507 (Angadjivand, et al.); U.S. Pat. No. 5,908,598 (Rousseau, et al.); U.S. Pat. No. 6,375,886 (Angadjivand, et al.); U.S. Pat. No. 6,406,657 (Eitzman, et al.); U.S. Pat. No. 6,454,986 (Eitzman, et al.); and U.S. Pat. No. 6,743,464 (Insley, et al.). In a preferred embodiment, water is employed as the polar hydrocharging liquid, and the media is exposed to the polar hydrocharging liquid using jets of the liquid or a stream of liquid droplets provided by any suitable spraying method.

Devices useful for hydraulically entangling fibers are generally useful for carrying out hydrocharging, although the operation is carried out at lower pressures in hydrocharging than generally used in hydroentangling. U.S. Pat. No. 5,496,507 (Angadjivand, et al.) describes an exemplary apparatus in which jets of water or a stream of water droplets are impinged upon the fibers in web form at a pressure sufficient to provide the subsequently-dried media with a filtration-enhancing electret charge.

The water pressure used to achieve optimum results generally depends on the type of sprayer used, the type of polymer from which the fiber is formed, the thickness and density of the web, and whether pretreatment such as corona charging was carried out before hydrocharging. Generally, pressures in the range of about 69 to about 3450 kPa can be used for this purpose.

The electret fibers may be subjected to other charging techniques in addition to or alternatively to hydrocharging, including electrostatic charging, tribocharging or plasma fluorination. Corona charging followed by hydrocharging and plasma fluorination followed by hydrocharging are particularly suitable charging techniques used in combination.

In some exemplary embodiments, the electret fibers can have a length of from 10 mm to 100 mm. Fiber cross-section need not be particularly restricted and can be circular, triangular, square, rectangular, generally polygonal, or any other cross-sectional shape. In one exemplary embodiment, the electret fibers can have a length in the range of from 38 mm to 90 mm.

Further options are possible. For example, the non-woven electret fibrous webs can include multi-component fiber components. Bi-component fibers can include polymers having different melting temperatures that are arranged in a core-sheath structure to provide inter-fiber bonding. Filling fiber components, including metal, ceramic, or natural fiber components, may also be incorporated into the fibrous web. The non-woven electret fibrous webs can also include any number binder components or other particulate components that are solid at ambient conditions. Exemplary additives are described in further detail in U.S. Pat. No. 9,802,187 (Fu, et al.).

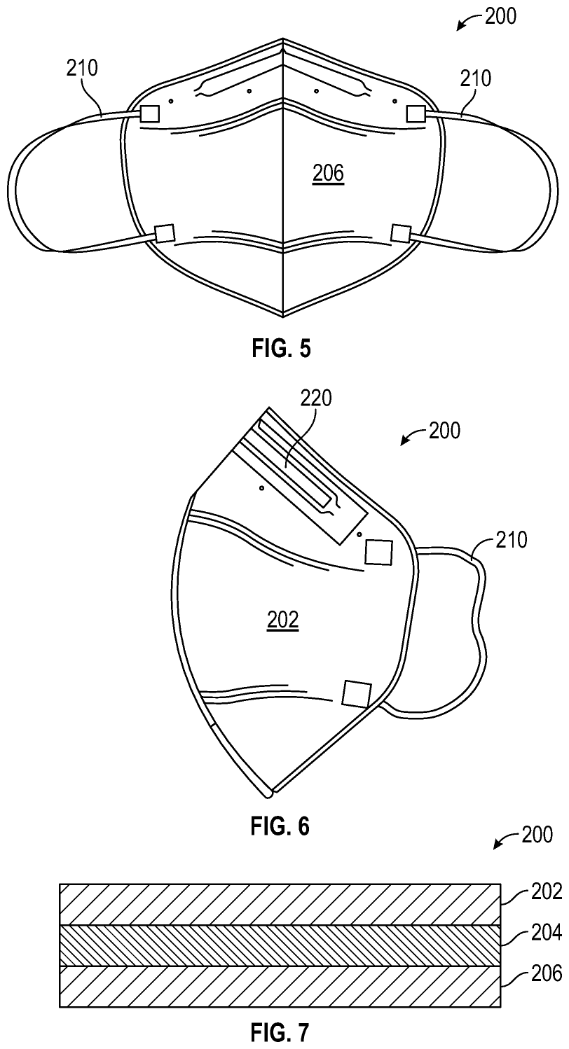

FIGS. 5 and 6 illustrate a face covering 200 according to an alternative embodiment. The face covering 200 incorporates certain features similar to those in the face covering 100 but has a somewhat simplified construction. As shown, the cover panel 202, filter 204 (visible in FIG. 7), and inner panel 206 are generally co-extensive and integrated into a bonded multilayered construction. In this construction, the cover panel 202 and inner panel 206 fully or at least substantially enclose the filter 204 within the face covering 200. Primary advantages to this embodiment can include lower cost, lighter weight, and no need for washing given that the entire construction is disposable.

An additional feature particular to face covering 200 is its inclusion of a nose wire 220 that assists in conforming the face covering 200 to the bridge of the wearer's nose and can be affixed to the front major surface of the cover panel 202. If so desired, the nose wire 220 can also be embedded within the face covering 200. Such a configuration could be achieved, for example, by sliding the nose wire 220 into an elongated pocket formed into either the cover panel 202 or inner panel 206.

FIG. 7 is a cross-sectional schematic revealing a layered structure not visible in FIGS. 5 and 6. In useful embodiments, the front-facing cover panel 202 and the rear-facing inner panel 206 can be made from any of the suitable cover panel materials described above. Further, the embedded filter 204 can be made from any of the filtration media described above. While not shown here, one or more additional filters 204 may be embedded between the cover panel 202 and the inner panel 206 to further improve filtration performance.

Remaining options and advantages associated with the components of the face covering 200 have been previously examined and shall not be repeated here.

### Examples

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight.

### Test Methods

### Pressure Drop Testing

Pressure drop was measured using a TSI 8130 air filtration tester provided by TSI Inc., Shoreview, MN. An air flow rate of 85 liters per minute was used for testing fully-assembled face coverings. A face velocity of 10 cm/s was used for measuring pressure drop for flat, stock components of the face covering (i.e., cover panel materials, filtration media, and gasket materials).

### Penetration Testing

Penetration testing was conducted using sodium chloride as a testing aerosol. Particles were generated with a 2% NaCl solution and filtration efficiency measured using a TSI 8130 air filtration tester according to requirements for certification provided in 42 Code of Federal Regulations Part 84, Approval of Respiratory Protective Devices. The NaCl particles were generated at a mass mean diameter of approximately 0.26 pm (count median diameter of approximately 0.075 pm), according to the TSI CERTITEST Automated Filter Testers Model 8130 data sheet.

### Fit and Performance Testing

Fit testing was performed to ASTM F3502-21, Standard Specification for

Barrier Face Coverings published February 2021, using Test Method F3407-20, Standard Test Method for Respirator Fit Capability for Negative-Pressure Half-Facepiece Particulate Respirators, published October 2020. ASTM F3502 notes, per Note 23, that for the purposes of this testing, a leakage ration replaces respirator fit capability referred to in Test Method F3407. Deviations: per 8.3.3, Fit was evaluated using the NIOSH Bivariate Panel specified in Test method F3407, using and averaging the results from 10 subjects, one from each of the ten cells, 1 through 10. This was done because the invention size designation is one size, not small, medium or large per 8.3.3.7

Performance testing ASTM F3502-21, Standard Specification for Barrier Face Coverings published February 2021. Deviations: per 7.0, Samples and Conditioning, specifically 7.3.1, Conditioning per the conditions specified in 8.1.1.5; prior studies conducted allowed deviation for polyester, nylon, spandex-blend fabrics not being conditioned as specified in 8.1.1.5 prior to AFT testing, where AFT results were compared before and after aging, with and without conditioning and resulted in less than 1% difference, within the margin of error. The polyester, nylon and spandex-blend fabrics were not conditioned prior to component AFT and thickness testing. Full constructions were conditioned before testing.

Face coverings and components thereof were tested according to ASTM 3502-21, Standard Specification for Barrier Face Coverings, published February 2021. Deviations: per 7.0, Samples and Conditioning, specifically 7.3.1, Conditioning per the conditions specified in 8.1.1.5; prior studies conducted allowed deviation for polyester, nylon, spandex-blend fabrics not being conditioned as specified in 8.1.1.5 prior to AFT testing, where AFT results were compared before and after aging, with and without conditioning and resulted in less than 1% difference, within the margin of error. The component polyester, nylon and spandex-blend fabrics were not conditioned prior to AFT, thickness testing. Full constructions were conditioned before testing.

### Materials

### Dual-Layer Spunbond Non-Woven Web Preparation

Non-woven fibrous webs were made using a 0.5 m spunbond web maker in which fibers were formed as extruded polypropylene exited spinnerets at the bottom of a die and were drawn vertically through a quench zone fed with chilled air into an attenuator supplied with compressed air. The fibers were then laid down semi-randomly on a moving collector belt forming a non-woven web. The non-woven web was held in place by vacuum until passing through a bonding zone where the web was then taken up on a surface winder. By varying the temperature and the position of a through air bonder (TAB), a gradient web with different solidities was obtained.

### Prefilter Ultrasonic Bonding Preparation

A multilayer re-lofted and charged non-woven web was prepared by ultrasonic bonding. Three layers of web were used: a re-lofted spunbond non-woven web having a 75-110 gsm basis weight, 10 gsm inner spunbond web, and cover web having a basis weight of 50 gsm.

### Final Assembly

Certain samples (samples 24, 25, 28, and 31) were directed to fully-assembled face coverings and were assembled as follows. Filters were made from the spunbond nonwoven filter media as manufactured above. For samples 24, 25, 28 and 31, cover panels were made from polyester mesh knit fabric by cutting it into an appropriate pattern. Gaskets were prepared from a polyester-spandex knit fabric as the side contacting the wearer's face by cutting a large, approximately circular opening into the polyester-spandex knit fabric. Chin panels were prepared from the polyester-spandex knit fabric. Using the designated pattern, these components were sewn together with the nose wire sewn and secured between layers of the cover panel to create a pocket using the to form a deep-drawn cupped shape as shown in FIGS. 1-4. Polyester-spandex elastic ear bands were sewn to the body.

For samples 50 to 53, an alternative face covering was made as shown in FIGS. 5 and 6 by ultrasonic welding two layers of cover web nonwoven materials along each major surface of the dual-layer spunbond media used as the filtration media, with each layer formed into a deep-drawn shape as described above. Elastic side bands attached to the cover panel by a separate welding operation.

### Results

Physical web properties are provided in Table 1 for a standard spunbond web (sample 1) and a dual-layer gradient inter-fiber bonding spunbond web (samples 2 and 3).

TABLE 1
Properties of spunbond non-woven webs.

| Sample | Thickness (mm) | Solidity (%) |
|---|---|---|
| 1 | 1.20 | 11.28 |
| 2 | 1.24 | 11.28 |
| 3 | 1.33 | 10.15 |

Table 2 provides the pressure drop (PD) and degree of penetration (Pen %) of the Sample 1 and the dual-layer gradient inter-fiber bonding spunbond web. It shows that the dual-layer web has better cross web uniformity from pressure drop and penetration performance. Properties were measured at five transverse positions across the web denoted as 1-5, where 1 and 5 were near the edge of the web, 3 was at the midpoint, and 2 and 4 at intermediate points between positions 1 and 3 and 3 and 5, respectively.

TABLE 2
Spunbond non-woven uniformity comparison
of standard and dual-layer webs

| Cross web | Sample 1 | | Samples 2, 3 | |
|---|---|---|---|---|
| position | PD | Pen % | PD | Pen % |
| 1 | 3.3 | 5.02 | 2.8 | 4.43 |
| 2 | 2.7 | 7.38 | 2.6 | 4.04 |
| 3 | 2.5 | 8.54 | 2.8 | 4.26 |
| 4 | 2.9 | 6.88 | 2.6 | 4.75 |
| 5 | 2.7 | 7.31 | 2.5 | 4.02 |
| Standard | 0.29 | 1.19 | 0.12 | 0.480 |
| deviation | | | | |

Fit test results are provided in Table 3 for sample respirators made according to sample 25 with filter test materials having basis weights of 60 g/m² and 120 g/m². Calculated average leakage ratios are provided in Table 4. The classifier was off for all samples per ASTM F3502, Test Method F3407.

TABLE 3
Uncorrected fit testing results performed according to Test Method F3407

| | | | | | | | | | | Leakage |
|---|---|---|---|---|---|---|---|---|---|---|
| | | Sample | | | | | | | | Ratio |
| | NIOSH | Basis | | | Side | Up | | Bending | | per |
| | Bivariate | Weight | Normal | Deep | to | and | Rainbow | at | Normal | ASTM |
| Sample | Panel Cell | (g/m²) | Breathing | Breathing | Side | Down | Passage | Waist | Breathing | F3407 |
| 4 | 6 | 120 | 11 | 8 | 10 | 14 | 7 | 7 | 8 | 9 |
| 5 | 6 | 60 | 8 | 7 | 7 | 10 | 5 | 7 | 7 | 7 |
| 6 | 2 | 60 | 6 | 9 | 6 | 7 | 5 | 4 | 6 | 6 |
| 7 | 2 | 120 | 7 | 10 | 8 | 8 | 7 | 5 | 6 | 7 |
| 8 | 3 | 60 | 7 | 7 | 8 | 7 | 5 | 6 | 7 | 7 |
| 9 | 3 | 120 | 6 | 3 | 5 | 5 | 7 | 4 | 6 | 5 |
| 10 | 10 | 120 | 12 | 8 | 10 | 9 | 8 | 6 | 8 | 8 |
| 11 | 10 | 60 | 7 | 5 | 6 | 5 | 4 | 5 | 5 | 5 |
| 12 | 7 | 60 | 11 | 8 | 10 | 11 | 6 | 8 | 13 | 9 |
| 13 | 7 | 120 | 12 | 10 | 11 | 9 | 9 | 7 | 8 | 9 |
| 14 | 5 | 120 | 4 | 4 | 5 | 8 | 5 | 4 | 4 | 5 |
| 15 | 5 | 60 | 3 | 3 | 5 | 6 | 6 | 3 | 4 | 4 |
| 16 | 1 | 60 | 8 | 9 | 9 | 9 | 7 | 8 | 9 | 8 |
| 17 | 1 | 120 | 11 | 11 | 10 | 10 | 8 | 6 | 7 | 9 |
| 18 | 8 | 120 | 17 | 16 | 15 | 11 | 10 | 6 | 16 | 12 |
| 19 | 8 | 60 | 10 | 10 | 9 | 8 | 6 | 8 | 8 | 8 |
| 20 | 4 | 60 | 9 | 10 | 10 | 11 | 7 | 8 | 10 | 9 |
| 21 | 4 | 120 | 12 | 13 | 14 | 13 | 10 | 10 | 13 | 12 |
| 22 | 9 | 120 | 11 | 10 | 14 | 12 | 9 | 7 | 10 | 10 |
| 23 | 9 | 60 | 10 | 8 | 11 | 12 | 6 | 6 | 8 | 8 |

TABLE 4
Leakage Ratio per Test
Method F3507 Subject Average

| | Leakage Ratio |
|---|---|
| 120 g/m² | 8.6 |
| 60 g/m² | 7.1 |

Performance test results are provided in Table 5. In Table 5, samples 24, 25, 28, 31, and 50-53 are examples, while samples 26, 27, 29, 30, 32, 43, and 44 are preparatory examples. For comparison, samples 33-38 were obtained from Outdoor Research, Seattle, WA; samples 39-42 were obtained from Airinum AB, Stockholm, Sweden, samples 45-46 were obtained from Honeywell International Inc., Charlotte, NC; and samples 47-49 were obtained from Pform Innovations LLC, Newport Beach, CA.

In Table 5, “Fixture” refers to mounting hardware used to position and support the face covering during AFT testing per ASTM F3502 such that the face covering is held in a shape that maximizes the surface area tested. The face coverings using a gasket used fixtures with a customized shape, while the cup-style face coverings used fixtures with rings or tents based on the shape of the product. For the flat sheets, fixtures used an orifice to stabilize the testing material.

TABLE 5
Performance testing per ASTM F3502.

| | | | Volumetric | Pressure | Filter | |
|---|---|---|---|---|---|---|
| | | | flow | Drop | Efficiency | Thickness |
| Sample | Description | Fixture | (liters/min) | (mm H₂O) | (%) | (mm) |
| 24 | cover panel, filter, | Custom fixture | 85 | 4.27 | 94.59% | 10.6 |
| | and gasket | | | | | |
| 25 | cover panel, filter, | Custom fixture | 85 | 4.06 | 94.40% | 10.48* |
| | and gasket | | | | | |
| 26 | cover panel | Custom fixture | 85 | 0.4 | 73% | 2.09* |
| 27 | Gasket | 2.54 cm diameter | 10 cm/s face | 9.46 | 23.7 | 0.85 |
| | | aperture | velocity | | | |
| 28 | cover panel, filter, | Custom fixture | 85 | 4.15 | 96.40% | 10.28 |
| | and gasket | | | | | |
| 29 | cover panel | Custom fixture | 85 | 0.25 | 67% | 2.31 |
| 30 | Gasket | 2.54 cm diameter | 10 cm/s face | 5.36 | 15.16% | 0.71 |
| | | aperture fixture | velocity | | | |
| 31 | cover panel, filter, | Custom fixture | 85 | 3.83 | 95.57% | 10.1* |
| | and gasket | | | | | |
| 32 | cover panel | Custom fixture | 85 | 0.3 | 20.43% | 2.09 |
| 33 | cover panel, filter, | Ring fixture | 85 | 1.8 | 65.60% | 9.04* |
| | and gasket | | | | | |
| 34 | cover panel, filter, | Ring fixture | 85 | 1.6 | 61.27% | 9.0 |
| | and gasket | | | | | |
| 35 | cover panel, filter, | Custom fixture | 85 | 8.4 | 73.00% | 9.1* |
| | and gasket | | | | | |
| 36 | cover panel | Ring fixture | 85 | 0.1 | 4% | 2.11 |
| 37 | Filter | 2.54 cm diameter | 10 cm/s face | 2.76 | 68% | 0.69 |
| | | aperture fixture | velocity | | | |
| 38 | gasket | 2.54 cm diameter | 10 cm/s face | 2.02 | 6.15% | 0.48 |
| | | aperture fixture | velocity | | | |
| 39 | cover panel, filter, | Ring fixture | 85 | 18.47 | 78.39% | 11.18* |
| | and gasket | | | | | |
| 40 | cover panel | not tested | not tested | not tested | not tested | 2.0 |
| 41 | filter | 2.54 cm diameter | 10 cm/s face | 10.8 | 99.80% | 1.75 |
| | | aperture fixture | velocity | | | |
| 42 | gasket | 2.54 cm diameter | 10 cm/s face | 135.45 | 95.40% | 0.45 |
| | | aperture fixture | velocity | | | |
| 43 | filter | Custom fixture | 85 | 1.6 | 75.80% | 0.81 |
| 44 | filter | Custom fixture | 85 | 2.9 | 91.95% | 1.21 |
| 45 | cover panel, filter, | Ring fixture | 85 | 11.1 | 91% | 8.52* |
| | and gasket | | | | | |
| 46 | filter | 6.5 cm diameter | 10 cm/s face | 6.74 | 89% | 1.09 |
| | | aperture fixture | velocity | | | |
| 47 | cover panel, filter, | Ring fixture | 85 | 12.8 | 94.80% | 10.06* |
| | and gasket | | | | | |
| 48 | filter | 6.5 cm diameter | 10 cm/s face | 10.6 | 96.80% | 0.94 |
| | | aperture fixture | velocity | | | |
| 49 | cover panel | not tested | not tested | not tested | not tested | 2.6 |
| 50 | 3-layer construction, | Tent Fixture | 85 | 2.4 | 87.3 | 1.21 |
| | spunbond filter | | | | | |
| | media, Basis wts: 50- | | | | | |
| | 60-12 (gsm) | | | | | |
| 51 | 3-layer construction, | Tent Fixture | 85 | 2.9 | 86.1 | 1.33 |
| | spunbond filter | | | | | |
| | media, Basis wts: 60- | | | | | |
| | 60-12 (gsm) | | | | | |
| 52 | 3-layer construction, | Tent Fixture | 85 | 1.8 | 87.3 | 1.0 |
| | spunbond filter | | | | | |
| | media, Basis wts: 30- | | | | | |
| | 60-12 (gsm) | | | | | |
| 53 | 3-layer construction, | Tent Fixture | 85 | 1.5 | 87.2 | 0.98 |
| | spunbond filter | | | | | |
| | media, Basis wts: 12- | | | | | |
| | 60-12 (gsm) | | | | | |

*Thickness of cover plus filter.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A face covering comprising:
(a) a cover panel comprising cover panel material and having a front major surface and a rear major surface and a perimeter;
(b) a filter comprising filtration media adjacent at least portion of the rear major surface of the cover panel;
(c) a gasket comprising gasket material connected to the perimeter of the cover panel configured to conform to a wearer's face; and
(d) a retaining system for securing the face covering to a wearer's face;
wherein the pressure drop across a combination of the cover panel material and the filtration media is from 45% to 75% of the pressure drop across the gasket material, as measured according to ASTM F3502.

2. The face covering of claim 1 further comprising a chin panel coupled to a bottom edge of the cover panel.

3. The face covering of claim 1, wherein the filtration media comprises an electret spunbond nonwoven media.

4. The face covering of claim 3, wherein the electret spunbond nonwoven media has a solidity gradient along its thickness dimension.

5. The face covering of claim 1, wherein the filtration media has a sub-micron filtration efficiency of at least 85%, as measured according to ASTM F3502.

6. The face covering of claim 1, wherein the filtration media has a pressure drop of from 0.5 mm H₂O to 5 mm H₂O, as measured according to ASTM F3502.

7. The face covering of claim 1, wherein the filtration media has a thickness of from 0.6 millimeters to 1.75 millimeters.

8. The face covering of claim 1, wherein the cover panel material has a pressure drop of from 0.05 mm H₂O to 1 mm H₂O, as measured according to ASTM F3502.

9. The face covering of claim 1, wherein the cover panel material has a thickness of from 1.5 millimeters to 3 millimeters.

10. The face covering of claim 1, wherein the cover panel material comprises a knit polyester spacer mesh, knit nylon mesh or a porous nonwoven.

11. The face covering of claim 1, wherein the gasket material has a thickness of from 0.3 millimeters to 1.2 millimeters.

12. The face covering of claim 1, wherein the gasket material comprises a polyester-spandex knit, a nylon-spandex knit or an elastic non-woven.

13. The face covering of claim 1, wherein the gasket material comprises at least 2% spandex/elastane.

14. The face covering of claim 1, wherein the gasket material has a pressure drop of from 2 mm H₂O to 20 mm H₂O, as measured according to ASTM F3502.

15. The face covering of claim 1, wherein the pressure drop across a combination of the cover panel material and the filtration media is from 0.5 mm H₂O to 5 mm H₂O, as measured according to ASTM F3502.

16. The face covering of claim 1, wherein the face covering provides a Fit Factor of 5 or greater, as measured according to ASTM F3407.

17. The face covering of claim 1, having a sub-micron filtration efficiency sub-micron filtration efficiency of at least 85%, as measured according to ASTM F3502.

18. The face covering of claim 1, wherein the face covering has an overall pressure drop of from 0.5 mm H₂O to 5 mm H₂O, as measured according to ASTM F3502.

19. The face covering of claim 1, wherein the filter is exposed along a central opening of the gasket and oversized relative to the central opening to provide an interference fit securing the filter between cover panel and the gasket.

20. A face covering comprising:
(a) a cover panel comprising cover panel material and having a front major surface and a rear major surface and a perimeter;
(b) a filter comprising filtration media adjacent at least portion of the rear major surface of the cover panel;
(c) an inner panel comprising an inner panel material adjacent to the filter, wherein the inner panel is configured to conform to a wearer's face; and
a retaining system for securing the face covering to a wearer's face, wherein the filtration media has a solidity gradient along its thickness dimension.
